(19) United States
(12) Patent Application Publication
(10) Pub. No.: US 2026/0079846 A1
(43) Pub. Date: Mar. 19, 2026

(54) ACTIVITY-BASED METADATA PAGING

(71) Applicant: Dell Products L.P., Round Rock, TX (US)

(72) Inventors: Malak Alshawabkeh, Franklin, MA (US); Rong Yu, West Roxbury, MA (US); Ramesh Doddaiah, Westborough, MA (US)

(73) Assignee: Dell Products L.P., Round Rock, TX (US)

(21) Appl. No.: 18/889,501

(22) Filed: Sep. 19, 2024

(51) Int. Cl. G06F 12/0868; G06F 11/30

(52) U.S. Cl. CPC G06F 12/0868; G06F 11/3058; G06F 2212/466

(57) ABSTRACT

A method, comprising: identifying an extent corresponding to a metadata page that is currently stored in a cache; calculating a predicted temperature score for the extent by using a time series forecasting model; detecting whether the predicted temperature score exceeds a first threshold; and extending a stay of the metadata page in cache in response to detecting that the predicted temperature score exceeds the first threshold, wherein the predicted temperature score is a measure of respective frequencies at which at least two different types of input-output I/O operations are expected to be received for the extent during a future time window.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: identifying an extent corresponding to a metadata page that is currently stored in a cache; calculating a predicted temperature score for the extent by using a time series forecasting model; detecting whether the predicted temperature score exceeds a first threshold; and extending a stay of the metadata page in cache in response to detecting that the predicted temperature score exceeds the first threshold, wherein the predicted temperature score is a measure of respective frequencies at which at least two different types of input-output I/O operations are expected to be received for the extent during a future time window.

According to aspects of the disclosure, a system, comprising: a memory; and at least one processor that is operatively coupled to the memory, the at least one processor being configured to perform the operations of: identifying an extent corresponding to a metadata page that is currently stored in a cache; calculating a predicted temperature score for the extent by using a time series forecasting model; detecting whether the predicted temperature score exceeds a first threshold; and extending a stay of the metadata page in cache in response to detecting that the predicted temperature score exceeds the first threshold, wherein the predicted temperature score is a measure of respective frequencies at which at least two different types of input-output I/O operations are expected to be received for the extent during a future time window.

According to aspects of the disclosure, a method is provided, comprising: identifying an extent corresponding to a metadata page that is currently not cached; calculating a predicted temperature score for the extent by using a time series forecasting model wherein the predicted temperature score is a measure of respective frequencies at which at least two different types of input-output I/O operations are expected to be received for the extent during a future time window; and pre-caching the metadata page based on the predicted temperature score.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of a computing device, according to aspects of the disclosure;

FIG. 3 is a flowchart of an example of a process, according to aspects of the disclosure;

FIG. 4 is a diagram of an example of a cache, according to aspects of the disclosure;

FIG. 5A is a flowchart of an example of a process, according to aspects of the disclosure;

FIG. 5B is a graph illustrating an example of temperature scores for a set of extents, according to aspects of the disclosure;

FIG. 6 is a flowchart of an example of a process, according to aspects of the disclosure;

FIG. 7 is a flowchart of an example of a process, according to aspects of the disclosure; and

FIG. 8 is a diagram of an example of a computing device, according to aspects of the disclosure.

### DETAILED DESCRIPTION

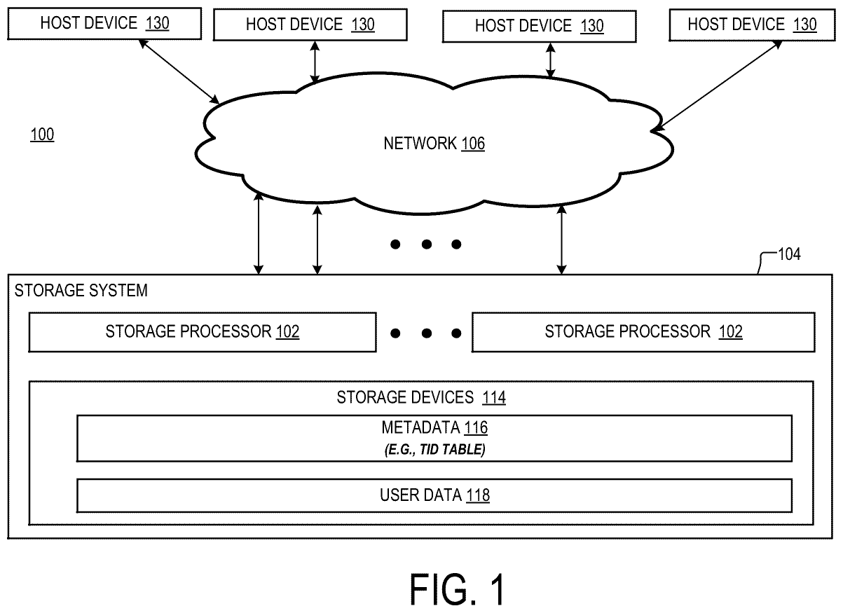

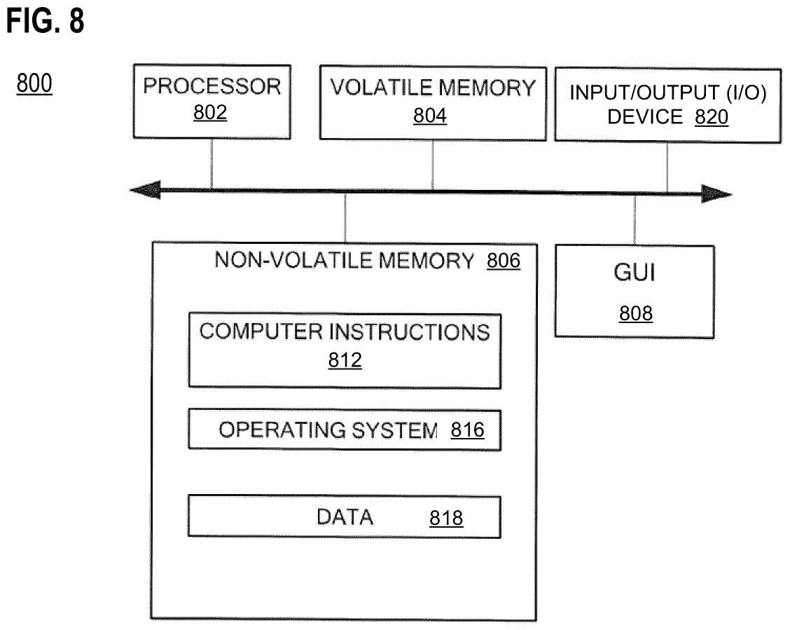

FIG. 1 is a diagram of an example of a system 100, according to aspects of the disclosure. As illustrated, system 100 may include a plurality of host devices 130 that are coupled via a communications network 106 to a storage system 104. Each of the host devices 130 may include a computing device, such as the computing device 800, which is discussed further below with respect to FIG. 8. Each of the host devices 130 may include one or more of a desktop computer, a smartphone, a laptop, and/or any other suitable type of computing device. The communications network 106 may include one or more of a local area network (LAN), a wide area network (WAN), a wireless network, a cellular network, a 5G network, the Internet, an InfiniBand network, and/or any other suitable type of network. Storage system 104 may include any suitable type of storage system, such as a location-addressable storage system or a content-addressable storage system, for example. Storage system 104 may include a plurality of storage processors 102 and one or more storage devices 114. Each of storage processors 102 may be a computing device, such as the computing device 800 that is discussed further below with respect to FIG. 8. Each of storage processors 102 may be configured to receive input-output (I/O) requests from host devices 130 and execute the I/O requests by reading or writing data from storage devices 114.

Storage devices 114 may include one or more solid-state drives (SSDs), one or more hard disks, one or more non-volatile memory express (NVMe) modules, and/or any other suitable type of storage devices. According to the present example, storage devices 114 are arranged to implement at least one Redundant Array of Independent Disks (RAID) array. Furthermore, according to the present example, the storage devices are configured to store user data 118 and metadata 116. The user data 118 may be any data that is desired to be stored and retrieved by the users of host devices 130 from the storage devices 114. For example, the user data 118 may include media content, documents, code, and so forth. The metadata 116 may include any data that is necessary for one or more of identifying the physical location where user data is stored, decoding the user data, performing a backup of the user data, and so forth. By way of example, the metadata 116 may include one or more of LBA-to-hash mappings, hash-to-physical address mappings, an indication of compression type/rate, an indication of I/O size, information necessary for performing data replication, and so forth.

In one example, the metadata 116 may be stored in a track ID (TID) table. The present disclosure is not limited to any specific implementation of the TID table. However, it is noted that in storage systems, the term “TID table” typically refers to data used to manage the IDs and other information associated with different tracks. As used herein, the term “track” refers to a unit of storage space. A set of consecutive tracks is herein referred to as an “extent”. An extent may include any number of tracks (e.g., 10, 20, etc.). A portion of the metadata 116 is herein referred to as a “metadata page”. In implementations in which metadata 116 is stored in a TID table, each of the metadata pages that form metadata 116 may be implemented as a different TID table page.

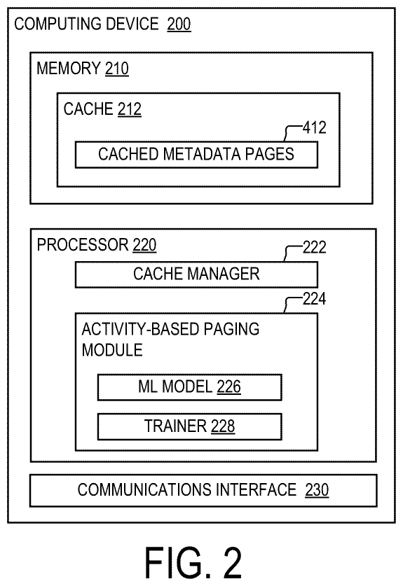

FIG. 2 is a diagram of an example of a computing device 200, according to aspects of the disclosure. Computing device 200 may be any suitable type of computing device that is part of storage system 104. For example, in some implementations, computing device 200 may be a storage processor (e.g., one of the storage processors 102). As another example, computing device 200 may be a management system. Stated succinctly, the present disclosure is not limited to any specific implementation of computing device 200.

As illustrated, computing device 200 may include a memory 210, a processor 220, and a communications interface 230. Memory 210 may include any suitable type of volatile or non-volatile memory, such as a solid-state drive (SSD), a hard disk (HD), a random-access memory (RAM), a Synchronous Dynamic Random-Access Memory (SDRAM), etc. Processor 220 may include any suitable type of processing circuitry, such as one or more of a general-purpose process (e.g., an x86 processor, a MIPS processor, an ARM processor, etc.), a special-purpose processor, an application-specific integrated circuit (ASIC), a field programmable gate array (FPGA), etc. The communications interface 230 may include any suitable type of communications interface. By way of example, the communications interface 230 may include one or more of an InfiniBand host bus adapter, an Ethernet adapter, or a Bluetooth adapter for example.

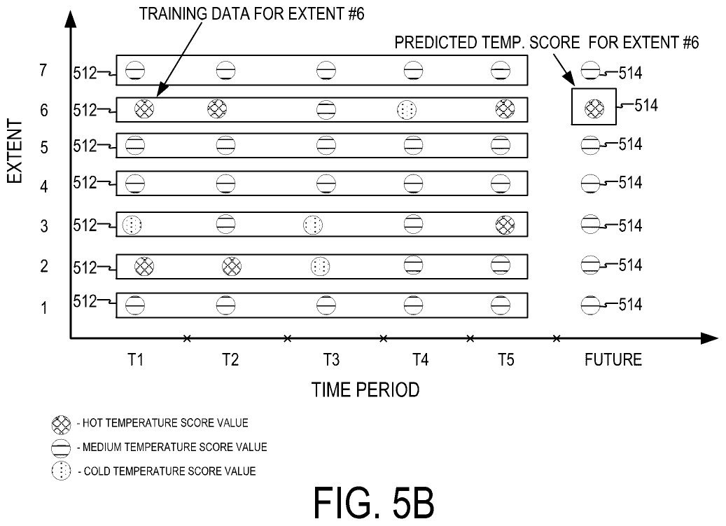

Memory 210 may be configured to store at least a portion of a cache 212. Cache 212 may be arranged to store one or more metadata pages 412 (which are part of the metadata 116). Processor 220 may be configured to execute a cache manager 222 and an activity-based paging (ABP) module 224. Cache manager 222 may be configured to store metadata pages in the cache 212 and destage data from the cache 212. The destaging of data may be performed by using a least recently used (LRU) algorithm. Cache manager 222 may be implemented in software, in hardware, or as a combination of software and hardware. Module 224 may include a machine learning model 226 and a trainer 228. Trainer 228 may include software, hardware, or a combination of software or hardware that is configured to train the model 226. Model 226 may be a time series forecasting model. According to the present example, model 226 is a Kaufman Adaptive Moving Average (KAMA) model. However, the present disclosure is not limited to any specific implementation of model 226. Model 226 may be implemented in hardware, software, or a combination of hardware and software. Model 226 is configured to predict the temperature scores for different extents in storage devices 114 (or a particular RAID array that is implemented by using storage devices 114). Examples of different methods for calculating temperature scores are provided further below with respect to FIG. 5.

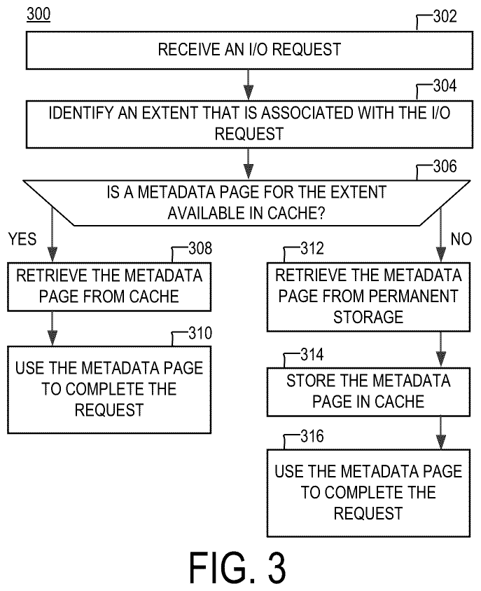

FIG. 3 is a flowchart of an example of a process 300, according to aspects of the disclosure. At step 302, computing device 200 receives an I/O request (e.g., a read request). At step 304, computing device 200 identifies an extent that is associated with the I/O request. At step 306, computing device 200 determines if a metadata page corresponding to the extent is already stored in the cache 212. If the metadata page is available in the cache 212, process 300 proceeds to step 308. Otherwise, process 300 proceeds to step 312. At step 308, computing device 200 retrieves the metadata page from cache 212. At step 310, computing device 200 uses the metadata page to complete the I/O request in a well-known fashion. At step 312, computing device retrieves the metadata page from the storage devices 114. At step 314, computing device stores the metadata page in the cache 212. At step 316, computing device 200 uses the metadata page to complete the I/O request in a well-known fashion. In some implementations, the flow consisting of steps 312-316 may take about 300 ms longer to complete than the flow of steps 308 and 310. This difference is attributable to the retrieval of the metadata page from permanent storage. In this regard, it will be understood that having metadata accurately pre-cached is advantageous because it can reduce the latency (or response times) of I/O requests that are incoming to computing device 200 and/or storage system 104. The discussion that follows provides examples of different techniques for caching or pre-caching of metadata.

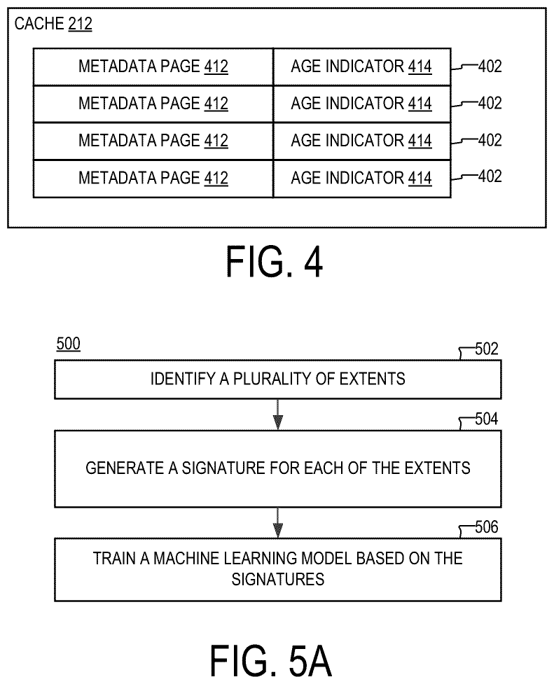

FIG. 4 is a diagram of the cache 212, according to aspects of the disclosure. As illustrated, the cache 212 may include a plurality of entries 402. Each entry 402 may include a different metadata page and a respective age indicator 414. The age indicator of any given entry 402 may be a number, string, or alphanumerical string which indicates the duration for which the given entry's respective metadata page 414 has been stored in the cache 212. The cache 212 may be stored in the DRAM modules of different storage processors 102. In other words, in some implementations, the cache 212 may be a global memory that is spread over the DRAM modules of different storage processors 104 and features a unified address space, which is accessible from each of the memory modules by using direct memory access (DMA) or remote direct memory access (RDMA) requests. However, it will be understood that the present disclosure is not limited to any specific implementation of the cache 212. For example, in some implementations, the entire cache 212 may be stored in the volatile memory of storage processor 102.

As noted above, the cache manager 222 may be arranged to use an LRU algorithm to destage different metadata pages 412 that are stored in the cache 212. The LRU algorithm may involve removing from cache metadata pages 412 that have been present in the cache 212 for the longest time. As noted above, the duration for which the metadata pages 412 have been stored in the cache 212 may be determined based on the age indicators 414.

FIG. 5A is a flowchart of an example of a process 500, according to aspects of the disclosure. At step 502, trainer 228 identifies a plurality of extents. The extends may be part of a RAID device or another storage device that is implemented by using the storage devices 114. It will be recalled that an extent is a set of sequential tracks. At step 504, trainer 228 generates a different respective signature for each of the extents. At step 506, trainer 228 trains the model 226 based on the signatures. The training may be performed by using any suitable type of training algorithm that is known in the art. By way of example, the training of model 226 may be performed by time series forecasting, which uses historical data points collected over time to make predictions about future values. The training data may be arranged in a sequence according to time intervals, such as daily, monthly, or yearly. The goal is to identify patterns or trends in the historical data to project future values, methods of time series forecasting that can be used include Autoregressive Integrated Moving Average (ARIMA), Seasonal Decomposition of Time Series (STL), Long Short-Term Memory (LSTM) and Recurrent Neural Networks (RNNs), and Prophet.

FIG. 5B shows a graph of a plurality of extent signatures 512. Each of the signatures 512 corresponds to a different respective extent. The extents in the example of FIG. 5B are enumerated 1 through 7. The signature 512 for any given one of the extents includes a plurality of temperature scores. In the example of FIG. 5B, each temperature score is represented by a circle. Depending on whether the value of a temperature score lies on a scale, the temperature score may be either hot, cold, or medium temperature. For example, on a scale of 0 to 1, any temperature score below 0.33 may be cold, any temperature score above 0.67 may be hot, and any temperature score in the range 0.34-0.66 may be medium temperature.

As noted above, the signature 512 for any given extent may include a plurality of temperature scores. Each temperature score may be calculated by observing the frequency of different I/O operations that involve the given extent during a different time window. Each time window, in the present example, has a duration of 5 minutes. However, the disclosure is not limited to any specific duration. In one example, each of the temperature scores may be calculated based on equations 1 and 2 below:

$${Score}_{i} = {\sum }_{d = 1}^{D} {w}_{d} * {F}_{d} \qquad ( 1 )$$

$$Temp S c o r {e}_{i} = a + \frac{( {Score}_{i} - {Score}_{min} ) ( b - a )}{{Score}_{max} - S c o r {e}_{min} )} \qquad ( 2 )$$

where Score is an observed temperature score (hereinafter “raw temperature score”), D is a total count of different input-output (I/O) operation types that are used in calculating Score, w is a weight that corresponds to one of the I/O operation types that bears index d, F is a frequency of the one of the I/O operation types that bears index d. As can be readily appreciated, equation 2 scales the result of equation 1 between a lower bound a and an upper bound b. In equation 2, Scoreₘᵢₙ is the minimum raw score in a signature (i.e., the raw score that is used as a basis for generating the smallest scaled temperature score in the signature). Furthermore, in equation 2, Scoreₘₐₓ is the maximum raw score in a signature (i.e., the raw score that is used as a basis for generating the largest scaled temperature score in the signature). In the present example, the signature includes a plurality of TempScoreᵢ values, where i is an index of the temperature score associated with the signature—in other words, the signature includes a plurality of scaled temperature scores. However, in some implementations, the signature may include raw temperature scores instead of scaled scores. In such implementations, equation 2 may be omitted and each member of the signature may be a raw temperature score.

As noted above, the value F is a frequency of the I/O operation that bears an index d. Consider an example in which d=1 corresponds to read operations, and d=2 corresponds to write operations. In this example, the value F₁ is the frequency of write requests that are received at the storage system 104 for the given extent during the time window that corresponds to the temperatue score. A write requests is considered to be “for the given extent” if the write request requests data to be written to an address that is part of the extent. The frequency of write operations may be equal to (or otherwise based on) the number of write operations per unit time that are received. Furthermore, in this example, the value F₂ is the frequency of read operations that are received at the storage system 104 for the given extent during the time window that corresponds to the temperature score. A read request is considered to be “for the given extent” if the read request requests data to be retrieved from an address that is part of the extent. The frequency of read operations may be equal to (or otherwise based on) the number of read operations per unit time that are received.

Continuing the above example, the value w₁ is a weight that is specific to write requests and is used to weigh the value F₁. Similarly, the value w₂ is a weight that is specific to read requests and used to weigh the value F₂. In the present example, two different types of I/O operations are used (i.e., read operations and write operations). However, in alternative implementations, equation 1 may consider a larger number of I/O operation types. For instance, in another example, D may be equal to 4 (D=4), where d=1 corresponds to random write requests, d=2 corresponds to sequential write requests, d=3 corresponds to random read requests, and d=4 corresponds to sequential read requests. It will be understood that the present disclosure is not limited to equation 1 considering any specific set of I/O operation types.

A definition of the term “temperature score” is not provided. The term “temperature score” as used throughout the disclosure shall mean any value that is at least in part based on the combined frequencies of at least two different types of I/O operations. In the example of equation 1, the temperature score is the weighted sum of the respective frequencies of read and write request for the extent that are received during a particular type of request. However, in alternative implementations, the temperature score may be just the sum of the frequencies, the average of the frequencies, the weighted average of the frequencies, the product of the frequencies, and so forth.

The signatures 512 may be used either during the training stage of the operation of model 226 or the inference stage of the operation of model 226. When used during the training stage, the signatures may be part of the training data set that is used to train the model 226 (discussed with respect to FIG. 5A).

When used during the inference stage, any of the signatures 512 may be classified with the model to produce a predicted temperature score for the extent that corresponds to the signature 512A. In other words, in some implementations, the model 226 may received as input the signature 512 for any given extent E and output a predicted temperature score for the extent E. The signature 512 may include a plurality of temperature scores, where each temperature score corresponds to a different time window in the past, and each temperature score is calculated by observing the frequency of different types of I/O operations that arrive for the extent E. The predicted temperature score that is generated by model 226 based on the signature 512 for extent E may be the temperature score which extent E is expected to have during a time window in the future. FIG. 5B shows an example of predicted temperature scores 514, where each temperature score 514 is generated by classifying a different respective one of the signatures 512. For example, the predicted temperature score 514 for extent 1 may be generated by classifying (with model 226) the signature 512 for extent 1, the predicted temperature score 514 for extent 2 may be calculated by classifying (with model 226) the signature 512 for extent 2, and so forth.

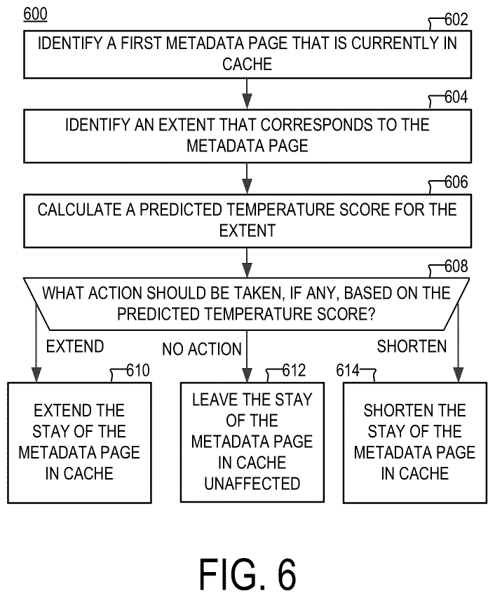

FIG. 6 is a flowchart of an example of a process 600, according to aspects of the disclosure.

At step 602, module 224 identifies a first metadata page that is currently stored in the cache 212.

At step 604, module 224 identifies an extent that corresponds to the metadata page.

At step 606, module 224 identifies a predicted temperature score for the extent. The predicted temperature score may be calculated in the manner discussed above. In one example, the predicted temperature score may be calculated by (1) generating a signature for the extent and (2) classifying the signature with model 226. The signature for the extent may be the same or similar to any of the signatures 512, which are discussed above with respect to FIG. 5B. As noted above, the signature may be generated by observing the frequency of different I/O operation types that are received for the extent and calculating their weighted sum. In some implementations, the signature may include a plurality of observed temperature values for the extent, wherein each observed temperature value is calculated in accordance with equations 1 and 2 above. In some implementations, each of the observed temperature values may be associated with a different time window and based on the frequencies of different I/O operation types during that time window.

At step 608, module 224 detects what action needs to be taken based on the predicted temperature score. Specifically, based on the temperature score (calculated at step 606), module 224 may detect whether to extend the stay, in cache 212, of the metadata page (identified at step 602), shorten the stay of the metadata page in cache 212, or leave unchanged the duration for which the metadata page is expected to remain in cache 212. In one example, module 224 may compare the predicted temperature score (calculated at step 606) to a first threshold T1 and a second threshold T2, wherein the first threshold T1 is less than the second threshold T2 (T1<T2). When the predicted temperature score is less than the first threshold T1, module 224 may determine that the stay of the metadata page in cache 212 needs to be shortened. When the predicted temperature score is greater than the second threshold T2, module 224 may determine that the stay of the metadata page in cache 212 needs to be extended. When the predicted temperature score is greater than or equal to the first threshold T1 and less than or equal to the second threshold T2, the module 224 may determine that the duration for which the metadata page would remain in cache 212 should be left unchanged. If it is determined to extend the stay of the metadata page in cache 212, processes 600 proceeds to step 610. If it is determined that the duration for which the metadata page would remain in cache 212 should be left unchanged, process 600 proceeds to step 612. If it is determined to shorten the stay of the metadata page in cache 212, process 600 proceeds to step 614.

At step 610, module 224 extends the stay of the metadata page in cache 212. In some implementations, extending the stay of the metadata page in cache 212 may include any action that would cause the metadata page to remain in cache 212 longer than if the action were not taken. For example, in some implementations, extending the stay of the metadata page in cache 212 may include decreasing the value of the age indicator 414 (shown in FIG. 4) that corresponds to the metadata page, so as to manipulate the cache manager 222 into thinking that the metadata page has spent less time in cache 212 than it actually has. As noted above, when cache manager 222 uses a least recently used algorithm to destage data, the age indicators 414 of metadata pages are incremented with time, and eventually destaged when their age indicator 414 crosses a threshold. In this regard, artificially decreasing the value of the age indicator 414 that corresponds to the metadata page (identified at step 602) would prolong the time it would take the age indicator 414 to cross the threshold.

At step 612, module 224 leaves the duration for which the metadata page will remain in cache 212 unchanged. In some implementations, step 612 may be performed by terminating process 600 without taking any action that affects the duration for which the metadata page will remain cache 212.

At step 614, module 224 shortens the stay of the metadata page in cache 212. In some implementations, shortening the stay of the metadata page in cache 212 may include any action that would cause the metadata page to remain in cache 212 for a shorter period of time than if the action were not taken. For example, in some implementations, shortening the stay of the metadata page in cache 212 may include increasing the value of the age indicator 414 (shown in FIG. 4) that corresponds to the metadata page, so as to manipulate the cache manager 222 into thinking that the metadata page has spent more time in cache 212 than it actually has. As noted above, when cache manager 222 uses a least recently used algorithm to destage data, the age indicators 414 of metadata pages are incremented with time, and eventually destaged when their age indicators 414 cross a threshold. In this regard, artificially increasing the value of the age indicator 414 that corresponds to the metadata page (identified at step 602) would reduce the time it would take the age indicator 414 to cross the threshold.

FIG. 6 is provided as an example only. At least some of the steps in the process 600 may be performed in a different order, in parallel, or altogether omitted. Although, in the present example, at step 614, the stay of the metadata page (identified at step 602) is shortened, alternative implementations are possible in which the metadata page is directly removed from the cache 212 at step 614. Although, in the present example, the stay of the metadata page in cache 212 is prolonged or shortened by artificially bumping up or down the age indicator 414 for the metadata page, alternative implementations are possible in which any other metric that is considered by the caching algorithm used by the cache manager 222 is either bumped up or down, so as to increase or decrease the probability that the metadata page would be destaged by the cache manager 222.

For example, if it is desired to extend the stay, in cache 212, of the metadata page, one or more metrics that are considered by the caching algorithm of cache manager 222 may be either increased or decreased so as to decrease the probability of cache manager 222 destaging the metadata page. For instance, the values may be decreased of one or more metrics that are directly proportional to the probability of the metadata page being destaged. Similarly, the values may be increased of one or more metrics that are inversely proportional to the probability of the metadata page being destaged. An example of a cache metric, other than age, that may be considered by a caching algorithm include frequency of access, etc.

As another example, if it is desired to shorten the stay, in cache 212, of the metadata page, one or more metrics that are considered by the caching algorithm of cache manager 222 may be either increased or decreased so as to increase the probability of cache manager 222 destaging the metadata page. For instance, the values may be increased of one or more metrics that are directly proportional to the probability of the metadata page being destaged. Similarly, the values may be decreased of one or more metrics that are inversely proportional to the probability of the metadata page being destaged.

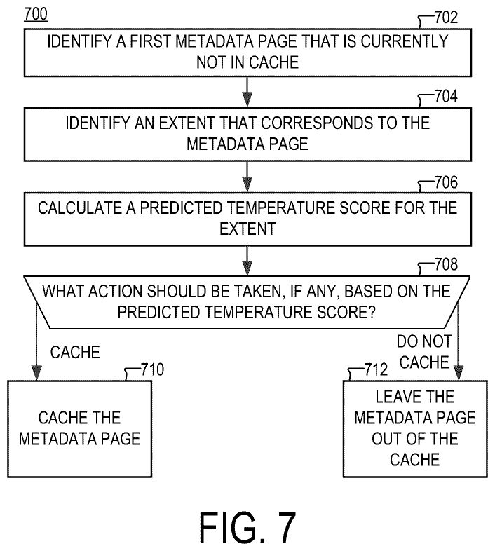

FIG. 7 is a flowchart of an example of a process 700, according to aspects of the disclosure. At step 702, module 224 identifies a first metadata page that is currently stored in the cache 212. At step 704, module 224 identifies an extent that corresponds to the metadata page. At step 706, module 224 identifies a predicted temperature score for the extent. Step 706 may be performed in the manner discussed above with respect to step 606 of process 600. At step 708, module 224 detects what action needs to be taken based on the predicted temperature score. Specifically, based on the temperature score (calculated at step 706), module 224 may detect whether to store the metadata page in cache 212 or leave the metadata page out of cache 212. For example, module 224 may compare the predicted temperature score to a threshold. If the predicted temperature score is above the threshold, module 224 may determine that the metadata page needs to be stored in the cache 212. On the other hand, if the predicted temperature score is less than or equal to the threshold, the metadata page may be left out of cache 212. If it is determined that the metadata page needs to be stored in cache 212, process 700 proceeds to step 710. If it is determined that the metadata page should stay out of cache 212, process 700 proceeds to step 712. At step 710, the metadata page is stored in the cache 212. At step 712, the metadata page is left out of cache 212. In some implementations, step 712 may be performed by terminating process 600 without taking any action that increases the probability of the metadata page being added to the cache 212.

FIG. 7 is provided as an example only. At least some of the steps in the process 700 may be performed in a different order, in parallel, or altogether omitted. Although, in the present example, at step 710, the metadata page (identified at step 702) is cached directly, alternative implementations are possible in which one or more metrics that are considered by the caching algorithm may be bumped up or down to increase the probability of the metadata page being cached. If, for example, the caching algorithm used by cache manager 222 considers frequency of use, the measured usage frequency of the metadata page may be artificially raised by 20% to increase the probability of cache manager 222 bringing the metadata page into cache 212.

Referring to FIG. 8, in some embodiments, a device 800 may include processor 802, volatile memory 804 (e.g., RAM), non-volatile memory 806 (e.g., a hard disk drive, a solid-state drive such as a flash drive, a hybrid magnetic and solid-state drive, etc.), graphical user interface (GUI) 808 (e.g., a touchscreen, a display, and so forth) and input/output (I/O) device 820 (e.g., a mouse, a keyboard, etc.). Non-volatile memory 806 stores computer instructions 812, an operating system 816 and data 818 such that, for example, the computer instructions 812 are executed by the processor 802 out of volatile memory 804. Program code may be applied to data entered using an input device of GUI 808 or received from I/O device 820.

FIGS. 1-8 are provided as an example only. In some embodiments, an I/O request may refer to a data read or write request. At least some of the steps discussed with respect to FIGS. 1-6 may be performed in parallel, in a different order, or altogether omitted. As used in this application, the word “exemplary” is used herein to mean serving as an example, instance, or illustration.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard ( 4/8).

It will be further understood that various changes in the details, materials, and arrangements of the parts which have been described and illustrated in order to explain the nature of the claimed invention might be made by those skilled in the art without departing from the scope of the following claims.

1. A method, comprising:
identifying an extent corresponding to a metadata page that is currently stored in a cache;
calculating a predicted temperature score for the extent by using a time series forecasting model;
detecting whether the predicted temperature score exceeds a first threshold; and
extending a stay of the metadata page in cache in response to detecting that the predicted temperature score exceeds the first threshold,
wherein the predicted temperature score is a measure of respective frequencies at which at least two different types of input-output I/O operations are expected to be received for the extent during a future time window.

2. The method of claim 1, wherein extending the stay of metadata page includes decrementing an age indicator that corresponds to the metadata page.

3. The method of claim 1, further comprising:
detecting whether the predicted temperature score is less than a second threshold, the second threshold being smaller than the first threshold; and
shortening the stay of the metadata page in cache in response to detecting that the predicted temperature score is less than the second threshold.

4. The method of claim 3, wherein shortening the stay of the metadata page in cache includes incrementing an age indicator that corresponds to the metadata page.

5. The method of claim 3, wherein the stay of the metadata page in cache is left unchanged when the predicted temperature score is greater or equal to the second threshold and less than or equal to the first threshold.

6. The method of claim 1, wherein the time series forecasting model includes a Kaufman Adaptive Moving Average (KAMA) model.

7. The method of claim 1, wherein the time series forecasting model is trained based on a plurality of observed temperature scores for the extent, any given one of the observed temperature scores being calculated, at least in part, based on the equation of:
$$Score = {\sum }_{d = 1}^{D} {w}_{d} * {F}_{d}$$
where Score is an observed temperature score or a value that is used as a basis for calculating the given observed temperature store, D is a total count of different input-output (I/O) operation types that are used in calculating Score, w is a weight that corresponds to one of the I/O operation types that bears index d, F is a frequency of the one of the I/O operation types that bears index d.

8. The method of claim 7, wherein the given observed temperature score is calculated by scaling Score.

9. A system, comprising:
a memory; and
at least one processor that is operatively coupled to the memory, the at least one processor being configured to perform the operations of:
identifying an extent corresponding to a metadata page that is currently stored in a cache;
calculating a predicted temperature score for the extent by using a time series forecasting model;
detecting whether the predicted temperature score exceeds a first threshold; and
extending a stay of the metadata page in cache in response to detecting that the predicted temperature score exceeds the first threshold,
wherein the predicted temperature score is a measure of respective frequencies at which at least two different types of input-output I/O operations are expected to be received for the extent during a future time window.

10. The system of claim 9, wherein extending the stay of metadata page includes decrementing an age indicator that corresponds to the metadata page.

11. The system of claim 9, wherein the at least one processor is further configured to perform the operations of:
detecting whether the predicted temperature score is less than a second threshold, the second threshold being smaller than the first threshold; and
shortening the stay of the metadata page in cache in response to detecting that the predicted temperature score is less than the second threshold.

12. The system of claim 11, wherein shortening the stay of the metadata page in cache includes incrementing an age indicator that corresponds to the metadata page.

13. The system of claim 11, wherein the stay of the metadata page in cache is left unchanged when the predicted temperature score is greater or equal to the second threshold and less than or equal to the first threshold.

14. The system of claim 9, wherein the time series forecasting model includes a Kaufman Adaptive Moving Average (KAMA) model.

15. The system of claim 9, wherein the time series forecasting model is trained based on a plurality of observed temperature scores for the extent, any given one of the observed temperature scores being calculated, at least in part, based on the equation of:
$$Score = {\sum }_{d = 1}^{D} {w}_{d} * {F}_{d}$$
where Score is an observed temperature score or a value that is used as a basis for calculating the given observed temperature store, D is a total count of different input-output (I/O) operation types that are used in calculating Score, w is a weight that corresponds to one of the I/O operation types that bears index d, F is a frequency of the one of the I/O operation types that bears index d.

16. The system of claim 15, wherein the given observed temperature score is calculated by scaling Score.

17. A method, comprising:
identifying an extent corresponding to a metadata page that is currently not cached;
calculating a predicted temperature score for the extent by using a time series forecasting model wherein the predicted temperature score is a measure of respective frequencies at which at least two different types of input-output I/O operations are expected to be received for the extent during a future time window; and
pre-caching the metadata page based on the predicted temperature score.

18. The method of claim 17, wherein the time series forecasting model is trained based on a plurality of observed temperature scores for the extent, any given one of the observed temperature scores being calculated, at least in part, based on the equation of:
$$Score = {\sum }_{d = 1}^{D} {w}_{d} * {F}_{d}$$
where Score is an observed temperature score or a value that is used as a basis for calculating the given observed temperature store, D is a total count of different input-output (I/O) operation types that are used in calculating Score, w is a weight that corresponds to one of the I/O operation types that bears index d, F is a frequency of the one of the I/O operation types that bears index d.

19. The method of claim 17, wherein the given observed temperature score is calculated by scaling Score.

20. The method of claim 17, wherein per-caching the metadata page based on the predicted temperature score includes detecting whether the predicted temperature score is greater than a threshold, the metadata page being pre-cached only when the predicted temperature score is greater than the threshold.
